(19) United States
(12) Patent Application Publication
(10) Pub. No.: US 2021/0379745 A1
(43) Pub. Date: Dec. 9, 2021

(54) Collapsible Nut Tool

(71) Applicant: Daniel Ballarin, Brisbane, CA (US)

(72) Inventor: Daniel Ballarin, Brisbane, CA (US)

(21) Appl. No.: 17/341,395

(22) Filed: Jun. 8, 2021

Related U.S. Application Data
(60) Provisional application No. 63/035,621, filed on Jun. 5, 2020.

(51) Int. Cl. B25B 27/00; A63B 29/02

(52) U.S. Cl. CPC B25B 27/00; A63B 29/024

(57) ABSTRACT

A simple hand held tool for removing climbing protection, with said tool's body comprising at least two sub-assemblies connected by a joint, rendering the tool able to modulate in size (by collapsing, folding, retracting, extending etc.). Size modulation additionally provides coverage or protection of the tool's hooked tip. This manually operated tool increases a user's safety and freedom of movement by modulating tool size, and preventing the nut tool hook or shaft from being a hazard or interfering with the user's activities, yet preserving normal nut tool function when in a deployed mode.

### TECHNICAL FIELD

This disclosure relates generally to tools used for rock climbing and mountaineering.

### BACKGROUND

### Description of the Related Art

The following is a tabulation of prior art that appears relevant:

### U.S. Patents

| Pat. No. | Issue Date | Patentee |
|---|---|---|
| US4,108,026A | 1978 Jul. 22 | Anderson et al. |

For decades, climbers have placed nuts, hexes, or camming units into features of a rock in order to protect themselves during climbing falls. Nuts, hexes, and camming units are examples of climbing protection, or protection. When climbing, one rope end is tied to a harness worn by a climber, and the opposite rope end is typically managed by another person called the belayer. The belayer will use a friction or rope grabbing device to minimize rope slack in the system, keep a potential fall as short as possible, and catch the climber should they fall. Most often, the climber places protection in a feature such as a crack while ascending. The climber then connects this protection to the rope via a carabiner. When placed properly, the protection will hold the force needed to stop the climber during a fall.

A typical sequence is that once the climber has ascended the climb, they will safely secure themselves to a weight bearing structure, commonly called an anchor. The belayer then becomes the second climber and follows the rope path toward the first climber, thus making upward progress. The first climber is now in the role of belaying the second climber, and similarly will manage slack in the system to keep a potential fall of the second climber as short as possible. As the second climber reaches a piece of protection (placed by the first climber), they will need to remove the protection to be reused on subsequent climbs. Protection can often be wedged into the rock feature very tightly for climber security, but this can also impede its removal. For situations like this, most climbers bring a nut tool, which is a hand held device to aid in the removal of protection, particularly chocks, chockstones, or nuts.

The nut tool has evolved little since the original patent was granted in 1978, and the same basic components still apply today. These components include a rigid flat body structure, a base handle, a middle shank, and a hook shaped tip. There are a variety of lengths, materials, and general shapes, but the body is comprised as a single piece.

The flat body structure allows the device to be inserted into narrow cracks. The base handle primarily functions for gripping, and optionally includes a thicker section to increase user comfort when the tool is used for prying or hammering. The handle in some models includes a spring wired gate that allows for the nut tool to be attached directly to a desired attachment point, such as a harness, to avoid accidental loss of the tool during its use. The middle shank creates mechanical leverage, and transmits forces from the base handle to the specialized tip. It also increases the reaching distance for the hook tip, for instance when the protection is wedged deeply within a crack. The tip includes both a recessed end and a flat appendage at a right angle to the shank creating a hook. Thus the tip of the shaft is able to push, pull, and pry, applying desired forces with the end goal of removing the protection from its placement.

While there are many useful functions for a nut tool, it can be burdensome and even dangerous in some instances. First, the tip of the nut tool, being hooked, is prone to catch on undesirable objects such as clothing, skin, rocks, branches, etc., and can cause the climber to have injuries, stumbles, trips, and other hazards. Another danger is that the length of a traditional nut tool is sufficiently long that during a fall, the device may rotate on the harness and inadvertently wedge or stab into the climber's body. These hazards can occur while climbing, while approaching the climb, and during the descent after the climb. Some climbers avoid bringing a nut tool due to these hazards, which then leaves the climber with fewer ways of removing protection that is tightly wedged in the rock. Sometimes the climber is then forced to leave behind climbing protection, taking a personal loss at the value of the climbing protection.

Accordingly, conventional solutions are generally inadequate to encourage a climber to bring a nut tool on their climb.

### SUMMARY

Disclosed herein is a collapsible nut tool that folds, retracts, or extends to modify the shaft length and guard, cover, or protect the nut tool hook, thereby improving usability and reducing potential hazards associated with tool usage.

### Advantages

Some embodiments have the advantage, among other advantages, of guarding the nut tool hook, improving usability, and decreasing the risk of potential hazards, such as accidental stabbing, associated with nut tool use and carriage. Other advantages of one or more aspects will be apparent from a consideration of the drawings and ensuing description.

### DRAWINGS—REFERENCE NUMERALS

100, 200, 300, 400, 500, 600 Collapsible nut tool, or device, or device body
105, 205, 405, 505, 605 Hook
110, 210, 410, 510, 610 Distal shank
115, 215, 515, 615 Liner lock cutout
120, 520 Detent ball
125, 225, 325, 525, 625 Pivot screw (Revolute joint)
130, 230, 330, 430, 530, 630 Stop pin
135, 235, 535, 635 Detent hole
140, 240, 340, 440, 540, 640 Liner lock
145, 245, 345, 445, 545, 645 Proximal shank
150, 250, 350, 450, 550, 650 Handle
155, 255, 355, 455, 555, 655 Wire gate
160, 360, 460, 560 Detent retaining hole
165 Pivot screw hole
170, 370, 470 Threaded pivot screw hole
175, 375, 475 Stop pin hole
180a Wire gate hole A
180b, 380b, 480b Wire gate hole B
185, 285, 585, 685 Stop pin cutout
190, 290, 390, 490, 590, 690 Proximal base sub-assembly
195, 295, 495, 595, 695 Distal tip sub-assembly

### BRIEF DESCRIPTION OF THE DRAWINGS

The accompanying drawings illustrate an embodiment of a collapsible nut tool.

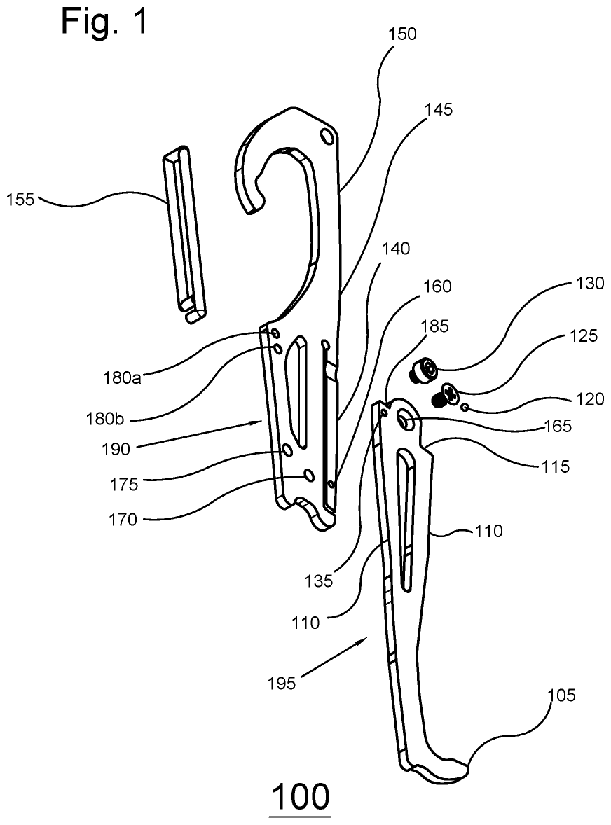

FIG. 1 illustrates an isometric front/left/top exploded view of a collapsible nut tool in a deployed mode.

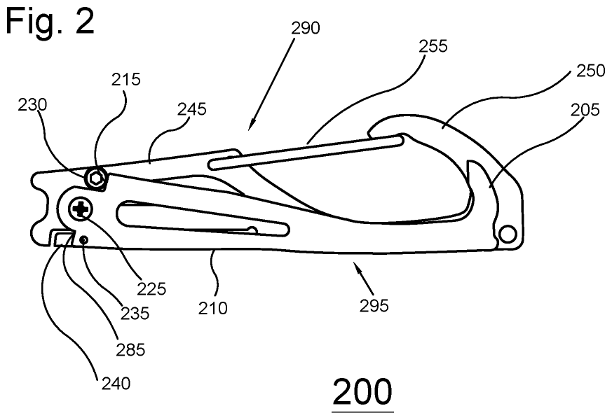

FIG. 2 illustrates a front view of a collapsible nut tool in a non-deployed mode.

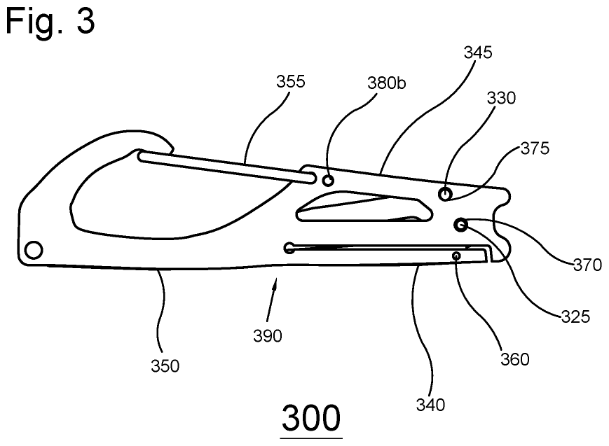

FIG. 3 illustrates a back view of a collapsible nut tool in a non-deployed mode.

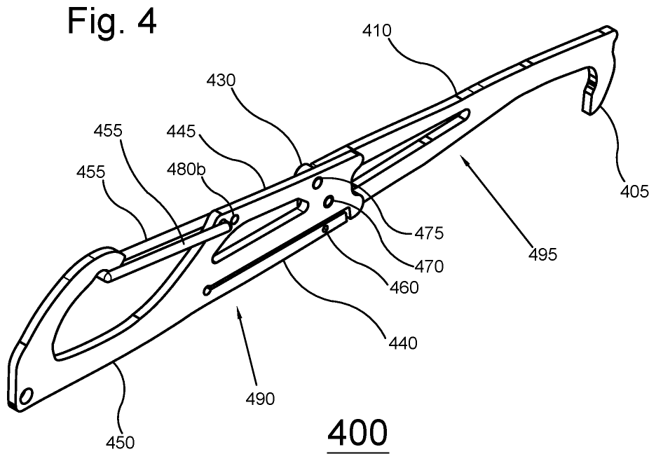

FIG. 4 illustrates an isometric back/right/top view of a collapsible nut tool in a deployed mode.

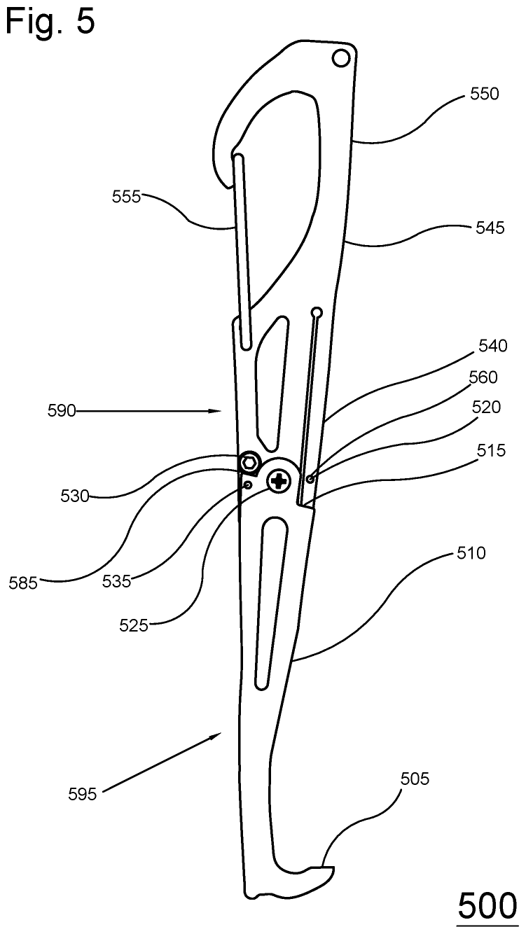

FIG. 5 illustrates a front view of a collapsible nut tool in a deployed mode.

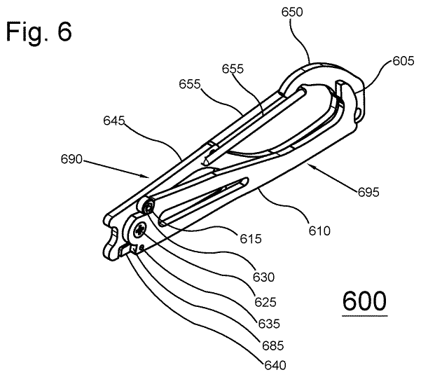

FIG. 6 illustrates an isometric front/left/top view of a collapsible nut tool in a non-deployed mode.

### DETAILED DESCRIPTION OF FIRST EMBODIMENT

Other advantages and features will become apparent from the following description of an embodiment of the invention given for non-restrictive example purposes only. Some embodiments of the invention are described with respect to the drawings. However, embodiments described herein are intended to be illustrative, and the invention contemplates other embodiments within the scope of the invention. Those skilled in the art will appreciate that the techniques and embodiments may also be practiced in other similar apparatus.

Reference will now be made in detail to the exemplary embodiments, examples of which are illustrated in the accompanying drawings. Wherever possible, the same reference numbers are used throughout the drawings to refer to the same or like parts. It is further noted that elements disclosed with respect to particular embodiments are not restricted to only those embodiments in which they are described. For example, an element described in reference to one embodiment or figure may be alternatively included in another embodiment or figure regardless of whether or not those elements are shown or described in another embodiment or figure. In other words, elements in the figures may be interchangeable between various embodiments disclosed herein, whether shown or not.

According to some embodiments with reference to FIG. 1 is an isometric front/left/top exploded view of a collapsible nut tool 100 in a deployed mode, which shall be referred to simply as device 100 or device body 100. Device 100 is typically composed of a rigid metal or metal alloy (such as aluminum, steel, titanium, or other similar lightweight and strong metals/metal alloys), although certain plastics or carbon fiber materials may also be suitable construction materials.

Device body 100, is comprised of a proximal base sub-assembly 190 and a distal tip sub-assembly 195, which can pivot on a revolute joint through the long axis of a pivot screw 125.

Proximal base sub-assembly 190 is comprised of eleven features and bodies: a detent ball 120, a stop pin 130, a detent retaining hole 160, a liner lock 140, a threaded pivot screw hole 170, a stop pin hole 175, a proximal shank 145, a wire gate hole A 180a, a wire gate hole B 180b, a wire gate 155, and a handle 150.

Distal tip sub-assembly 195 is comprised of six features: a hook 105, a distal shank 110, a pivot screw hole 165, a detent hole 135, a liner lock cutout 115, and a stop pin cutout 185.

Distal tip sub-assembly 195 at its extreme end contains an offset appendage referred to as hook 105, as is standard in a state of the art nut tool. Hook 105 transitions into the distal shank 110. Distal shank 110 creates the necessary length and geometry for the device 100 to apply desired forces to remove climbing protection, i.e., to function as a nut tool. Distal shank 110 includes four adjacent features: liner lock cutout 115, detent hole 135, pivot screw hole 165, and stop pin cutout 185. Pivot screw 125 may pass through pivot screw hole 165 and attach to threaded pivot screw hole 170 which is housed within proximal base sub-assembly 190. Proximal base sub-assembly 190 is thus connected to distal tip sub-assembly 195 by a revolute joint around pivot screw 125.

Detent hole 135 is a through-hole in this example, however may alternatively be a blind hole. Detent hole 135 interacts with spherical detent ball 120. Detent ball 120 is partially pressed into detent retaining hole 160, holding detent ball 120 in place under spring pressure. When device 100 is in a non-deployed mode, as will be described further in FIG. 2, the interaction of detent ball 120 and detent hole 135 creates a slip joint in order to prevent the nut tool from unintentional deployment.

A liner lock mechanism is created by the interaction of the liner lock 140 and the liner lock cutout 115. Liner lock 140 is an elongated appendage biased to spring in the frontward direction, projecting into the empty space created by liner lock cutout 115. When device 100 is in deployed mode, as shown here in FIG. 1, the distal tip of liner lock 140 will make contact with liner lock cutout 115. This contact causes an end stop to the revolute joint between proximal base sub-assembly 190 and distal tip sub-assembly 195, thus limiting the joint range of motion to a desired state. Simply put, the interaction between liner lock 140 and liner lock cutout 115 prevents the tool from unintentionally closing into the non-deployed mode when in use. To return device 100 to the non-deployed mode, liner lock 140 may be manually pushed in the backward direction, thus out of contact, with liner lock cutout 115. This action removes the end stop to the revolute joint and allows device 100 to rotate at the revolute joint around pivot screw 125 and return to the non-deployed mode.

A stop pin mechanism is created by the interaction of stop pin 130 and stop pin cutout 185. Distal tip sub-assembly 190 includes a small cutout, stop pin cutout 185. Stop pin 130 is fixed rigidly into stop pin hole 175 of proximal base sub-assembly 190. When device 100 is in the deployed mode, as shown here in FIG. 1, stop pin cutout 185 makes contact with stop pin 130. This interaction causes an end stop to the revolute joint at pivot screw 125 between proximal base sub-assembly 190 and distal tip sub-assembly 195, thus limiting the joint range of motion to a desired state and further preventing the device from unintentionally returning to the non-deployed mode when in use.

The end stops created by both the liner lock mechanism and the stop pin mechanism create a reversible yet rigid joint between proximal base sub-assembly 190 and distal tip sub-assembly 195. This rigid joint allows for normal functional use of the device 100 while in deployed mode, with an additional mechanism to unlock the rigid joint and rotate the sub-assemblies around the revolute joint, thus returning the device to the non-deployed mode.

Proximal shank 145 creates the necessary length and geometry for device 100 to function as a nut tool. Proximal base sub-assembly 190 may be constructed with two holes in proximal shank 145. These two holes, wire gate hole A 180a and wire gate hole B 180b, serve as attachment points for wire gate 155, thus creating a removable clip.

Handle 150 creates a surface for the user to hold device 100 while in use, and also creates the necessary geometry to cover and protect hook 105 when device 100 is in the non-deployed mode.

According to some embodiments with reference to FIG. 2 is a front view of a collapsible nut tool in a non-deployed mode, or device 200. Device 200 is comprised of proximal base sub-assembly 290 and distal tip sub-assembly 295, which are similar in implementation and description to proximal base sub-assembly 190 and distal tip sub-assembly 195 shown in FIG. 1, and which can pivot on a revolute joint along the long axis of pivot screw 225.

Distal tip sub-assembly 295 includes the features of hook 205 which transitions into the distal shank 210. Distal shank 210 creates the necessary length and geometry for proper functioning as a nut tool. Distal tip sub-assembly 295 further includes liner lock cutout 215 and stop pin cutout 285 at the opposite end of hook 205.

In the non-deployed mode, liner lock cutout 215 contacts stop pin 230 and may cause an end stop to the revolute joint between proximal base sub-assembly 290 and distal tip sub-assembly 295.

Distal tip sub-assembly 295 may include a detent ball mechanism, comprising detent hole 235, detent ball 220, and detent retaining hole 260. Detent ball 220 (not pictured) which may be partially pressed into detent retaining hole 260 (not pictured), both of which may reside within liner lock 240. In the non-deployed mode, as shown here in FIG. 2, detent hole 235 may articulate with detent ball 220, creating a slip joint to prevent the nut tool from unintentional deployment.

Proximal shank 245 may include attachment points for wire gate 255, thus creating a removable clip. Handle 250 creates a surface for the user to hold device 200 while in use, and also creates the necessary geometry to cover and protect hook 205 as shown here in non-deployed mode.

According to some embodiments with reference to FIG. 3 is a back view of a collapsible nut tool in a non-deployed mode, or device 300. Device 300 includes proximal base sub-assembly 390 which is similar in implementation and description to proximal base sub-assembly 190 as shown in FIG. 1, and which can pivot on a revolute joint along the long axis of pivot screw 325. Pivot screw 325 is housed within threaded pivot screw hole 370.

Proximal base sub-assembly 390 includes the features of handle 350, which creates a surface for the user to hold device 300 while in use, and proximal shank 345, which creates the necessary length and geometry for device 300 to function as a nut tool. Proximal shank 345 may also include attachment points such as wire gate hole B 380b for wire gate 355, thus creating a removable clip. Proximal base sub-assembly 390 includes stop pin hole 375 to accommodate stop pin 330. Proximal base sub-assembly 390 further includes liner lock 340, which houses detent ball 320 (not pictured) on the opposite (front) side of detent retaining hole 360.

According to some embodiments with reference to FIG. 4 is an isometric back/right/top view of a collapsible nut tool in a deployed mode, or device 400. Device 400 is comprised of proximal base sub-assembly 490 and distal tip sub-assembly 495, which are similar in implementation and description to proximal base sub-assembly 190 and distal tip sub-assembly 195 shown in FIG. 1. These two sub-assemblies can pivot on a revolute joint along the long axis of pivot screw 425. Proximal base sub-assembly 490 includes threaded pivot screw hole 470 which contains pivot screw 425.

Proximal base sub-assembly 490 is comprised of eleven features and bodies: detent ball 420 (not pictured), stop pin 430, liner lock 440, proximal shank 445, detent retaining hole 460, pivot screw hole 465, stop pin hole 475, wire gate hole B 480b, wire gate 455, and handle 450. Stop pin 430 lies within stop pin hole 475. Liner lock 440 in this view is biased to spring in the forward direction and to contact liner lock cutout 415 (not pictured) causing an end stop to the revolute joint between proximal base sub-assembly 490 and distal tip sub-assembly 495, thus preventing the nut tool from unintentionally returning to non-deployed mode when in use.

Distal tip sub-assembly 495 in this figure shows two of six features: hook 405, and distal shank 410, which creates the necessary length and geometry for device 400 to function as a nut tool. Distal tip sub-assembly includes liner lock cutout 415 (not pictured) which makes contact with liner lock 440, functioning as a liner lock mechanism described in paragraph [0026] above.

According to some embodiments with reference to FIG. 5 is a front view of a collapsible nut tool in a deployed mode, or device 500. Device 500 is comprised of proximal base sub-assembly 590 and distal tip sub-assembly 595, which are similar in implementation and description to proximal base sub-assembly 190 and distal tip sub-assembly 195 as shown in FIG. 1. These two sub-assemblies can pivot on a revolute joint along the long axis of pivot screw 525.

Proximal base sub-assembly 590 is comprised of eleven features and bodies: detent ball 520, stop pin 530, liner lock 540, proximal shank 545, handle 550, wire gate 555, detent retaining hole 560, pivot screw hole 565 (not pictured), stop pin hole 575 (not pictured), and wire gate hole B 580b (not pictured). Liner lock 540 is biased to spring in the forward direction and contacts liner lock cutout 515, causing an end stop to the revolute joint between proximal base sub-assembly 590 and distal tip sub-assembly 595, thus preventing the nut tool from unintentionally returning to non-deployed mode when in use. Manual pressure upon the spring force of liner lock 540 in the backward direction releases its contact with liner lock cutout 515, thereby removing the end stop and allowing distal tip sub-assembly 595 to rotate around pivot screw 525, thus returning device 500 to return to the non-deployed mode.

Proximal shank 545 creates the necessary length and geometry for device 500 to function as a nut tool. Handle 550 creates a surface for the user to hold device 500 while in use, and also creates the necessary geometry to cover and protect hook 505 when device 500 is in non-deployed mode. Detent ball 520 may be partially pressed into detent retaining hole 560, both of which may reside within liner lock 540. As shown here in deployed mode, detent ball 520 is not serving a function.

Distal tip sub-assembly 595 is comprised of six features: hook 505, distal shank 510, liner lock cutout 515, pivot screw hole 565 (not pictured), stop pin cutout 585, and detent hole 535. Hook 505 transitions into distal shank 510. Distal shank 510 creates the necessary length and geometry for device 500 to function as a nut tool.

Stop pin 530 is fixed rigidly into stop pin hole 575 (not pictured) of proximal base sub-assembly 590. Device 500 is shown in deployed mode, thus stop pin cutout 585 is making contact with stop pin 530. This interaction causes an end stop to the revolute joint between proximal base sub-assembly 590 and distal tip sub-assembly 595, preventing the nut tool from unintentionally returning to non-deployed mode when in use.

The end stops created by both stop pin 530 and liner lock 540 create a reversible yet rigid joint between proximal base sub-assembly 590 and distal tip sub-assembly 595. This rigid joint allows for normal functional use of the device 500 while in deployed mode.

According to some embodiments with reference to FIG. 6 is an isometric front/left/top view of a collapsible nut tool in a non-deployed mode, or device 600. Device 600 is comprised of proximal base sub-assembly 690 and distal tip sub-assembly 695, which are similar in implementation and description to proximal base sub-assembly 190 and distal tip sub-assembly 195 shown in FIG. 1, and which can pivot on a revolute joint along the long axis of pivot screw 625.

Proximal base sub-assembly 690 includes proximal shank 645, which creates the necessary length and geometry for device 600 to function as a nut tool. Proximal shank 245 may include attachment points for wire gate 655, thus creating a removable clip. Handle 650 creates a surface for the user to hold device 600 while in use, and also creates the necessary geometry to cover and protect hook 605. At the opposite end of handle 650 is liner lock 640. Detent ball 620 (not pictured) may be partially pressed into detent retaining hole 660 (not pictured), both of which may reside within liner lock 640. As shown here in non-deployed mode, detent ball 620 (not pictured) may articulate with detent hole 635, creating a slip joint to prevent device 600 from unintentional deployment.

Distal tip sub-assembly 695 includes features of hook 605, and distal shank 610, which creates the necessary length and geometry for device 600 to function as a nut tool. At the opposite end of hook 605 are features liner lock cutout 615 and stop pin cutout 685. While in the non-deployed mode, liner lock cutout 615 is making contact with stop pin 630 and preventing further rotation of distal tip sub-assembly 695 around pivot screw 625. Stop pin cutout 685 is not in direct contact with other features in the non-deployed mode, and is adjacent to the detent hole 635.

According to an alternative embodiment, the device body comprising a proximal base sub-assembly and a distal tip sub-assembly may connect via a sliding joint or a four bar linkage. In the case of the sliding joint, such as a sliding dovetail joint, the proximal base sub-assembly and the distal tip sub-assembly each contain interlocking dovetail shaped grooves which are able to slide longitudinally along each other, thus providing a mechanism for collapsing or expanding the device. In the case of a four bar linkage, the device body comprising a proximal base sub-assembly and a distal tip sub-assembly may connect via a four bar linkage, able to rotate and provide a mechanism for collapsing or expanding the device.

In some embodiments, the invention as claimed includes:

1. A tool for removing rock climbing protection which is capable of collapsing or extending, comprising:
a. a body divided into multiple parts, connected by a joint which renders said tool the ability to modulate substantially in size.

2. The tool according to claim 1, wherein said body is divided into a proximal base sub-assembly and a distal tip sub-assembly.

3. The tool according to claim 1, wherein said tool includes a hooked tip which is covered when said tool is modulated in size.

4. The tool according to claim 1, wherein said joint is a revolute joint, a sliding joint, or a four bar linkage.

5. The tool according to claim 1, wherein said joint is additionally bolstered by a liner lock mechanism, comprising a liner lock and a liner lock cutout, configured to limit the joint range of motion to a desired state.

6. The tool according to claim 1, wherein said joint is additionally bolstered by a stop pin mechanism, comprising a stop pin and a stop pin cutout, configured to limit the joint range of motion to a desired state.

7. The tool according to claim 1, wherein said nut tool is prevented from entering a deployed mode by use of a detent ball mechanism,
comprising a detent ball and a detent hole, configured such that the detent ball sits in the detent hole to create a slip joint which provides a temporary overridable lock, retaining the device in the non-deployed mode when engaged.
